(19) United States
(12) Patent Application Publication
(10) Pub. No.: US 2025/0384614 A1
(43) Pub. Date: Dec. 18, 2025

(54) PROFILING AND DEBUGGING FOR REAL TIME RAY TRACING

(71) Applicant: ADVANCED MICRO DEVICES, INC., Santa Clara, CA (US)

(72) Inventors: Budirijanto Purnomo, Boston, MA (US); Can Alper, Boston, MA (US); David Andrew DiGioia, Boston, MA (US); Martin Dinkov, Orlando, FL (US); Michael Alexander Kern, Munich (DE); Rohan Mehalwal, Orlando, FL (US); Ryan P. Kennedy, Cambridge, MA (US); Steven Tovey, Milton Keynes (GB)

(21) Appl. No.: 18/744,085

(22) Filed: Jun. 14, 2024

(51) Int. Cl. G06T 15/06; G06T 1/60

(52) U.S. Cl. CPC G06T 15/06; G06T 1/60

(57) ABSTRACT

A processing system captures raw ray traversal data from a real-time ray tracing application and generates tokens that are compact representations of various aspects of the ray tracing data from which the ray traversal data can be reconstructed and analyzed. For example, a token stream includes tokens having identifiers to uniquely identify a ray in a ray dispatch, a call site within a shader, traversal iteration and parent traversal. Other tokens in the stream may include associated ray and top level and bottom level acceleration structure data, intersection result, function call, hits, and ray user payload data. An analysis and visualization application accesses the stored tokens, parses the tokens, and reconstructs the ray traversal data represented by the tokens for subsequent analysis.

### BACKGROUND

To improve the fidelity and quality of generated images, some software, and associated hardware of a processing system, implement ray tracing operations, wherein the images are generated by tracing the path of light rays associated with the image. By extension, path tracing is a technique for shooting multiple rays per pixel in random directions and can be used to solve more complex lighting situations. A processing system performs ray and path tracing by shooting rays from a camera toward a scene and intersecting the rays with the scene geometry to construct light paths. As objects are hit, the processing system generates new rays on the surfaces of the objects to continue the paths.

To more efficiently determine which objects from a scene a particular ray is likely to intersect, some of these ray tracing operations employ an acceleration structure, such as a bounding volume hierarchy (BVH) tree, to represent a set of geometric objects within a scene to be rendered. The geometric objects (e.g., triangles or other primitives) are enclosed in bounding boxes or other bounding volumes that form leaf nodes of the tree structure, and then these nodes are grouped into sets, with each set enclosed in its own bounding volume that is represented by a parent node on the tree structure, and these sets then are bound into larger sets that are similarly enclosed in their own bounding volumes that represent a higher parent node on the tree structure, and so forth, until there is a single bounding volume representing the top node of the tree structure and which encompasses all lower-level bounding volumes. To perform some ray tracing operations, the tree structure is used to identify potential intersections between generated rays and the geometric objects in the scene by traversing the nodes of the tree, where at each node being traversed a ray of interest is compared with the bounding volume of that node to determine if there is an intersection, and if so, continuing on to a next node in the tree, where the next node is identified based on the traversal algorithm, and so forth.

The processing system computes color values for each of the rays and determines the values of pixels of an image for display based on the color values. However, the computational processing and memory bandwidth load of ray tracing is heavy, and debugging and profiling of real-time ray tracing functionality is difficult for application and driver developers, as ray traversal data is not readily available due to memory and other processing resource constraints.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to capture real-time ray traversal data and tokenize the data for analysis and debugging in accordance with some embodiments.

FIG. 2 is a block diagram of a driver generating tokens representing recorded ray traversal data for storage in accordance with some embodiments.

FIG. 3 is a block diagram of a processing system reconstructing ray traversal data from stored tokens for analysis and debugging in accordance with some embodiments.

FIG. 4 is an illustration of visualization of analysis of ray traversal data reconstructed from stored tokens in accordance with some embodiments.

FIG. 5 is an illustration of a heat map generated from ray traversal data reconstructed from stored tokens in accordance with some embodiments.

FIG. 6 is a flow diagram illustrating a method for tokenizing ray traversal data captured from real-time ray tracing functionality and reconstructing the ray traversal data for analysis and debugging in accordance with some embodiments.

### DETAILED DESCRIPTION

Typical graphics application programming interfaces (APIs) do not allow capture of ray traversal data (also referred to as ray tracing data) from real-time ray tracing applications, which poses difficulties for debugging and profiling of real-time ray tracing functionality. In particular, ray tracing and path tracing can remain opaque to developers, with an indeterminate traversal cost for various geometries. Thus, a developer may not be aware of the cost (e.g., in computation and bandwidth) of rendering portions of a frame. Consequently, unwarranted computing resources may be expended on portions of a frame that are unimportant (e.g., because they are occluded or outside screen space or in an area on which a user is unlikely to focus).

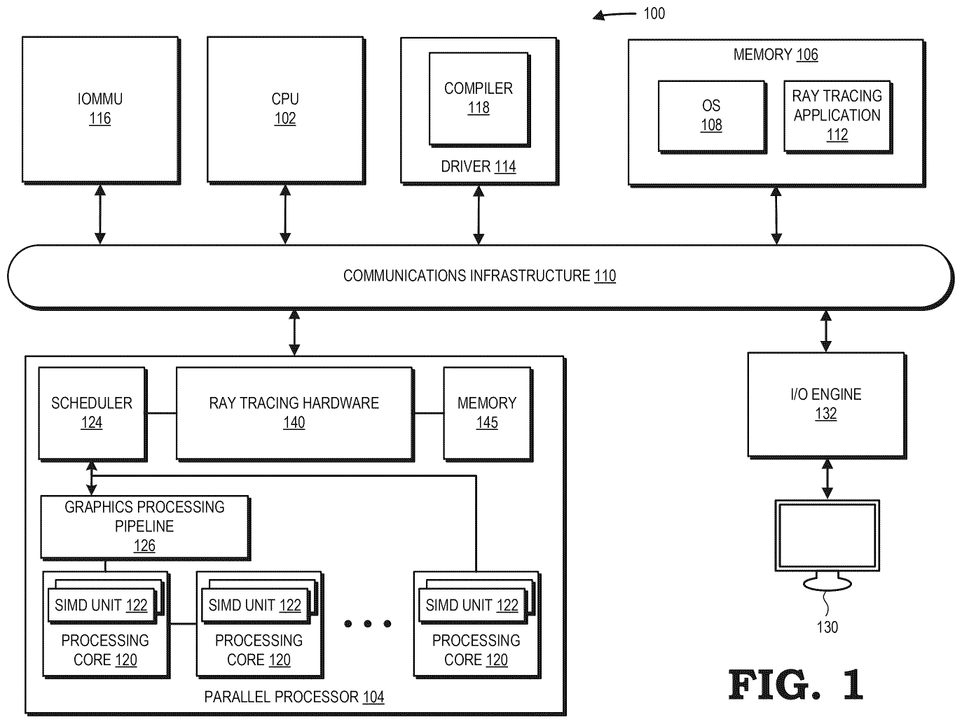

To facilitate profiling and debugging of ray traversal data in real time ray tracing pipelines, FIGS. 1-6 illustrate techniques for capturing raw ray tracing data and generating tokens that are compact representations of various aspects of the ray tracing data from which the ray tracing data can be reconstructed and analyzed. For example, in some implementations, a token stream includes tokens having identifiers to uniquely identify a ray in a ray dispatch, a call site within a shader, traversal iteration and parent traversal. Other tokens in the stream may include associated ray and top level and bottom level acceleration structure data, intersection result, function call, hits, and ray user payload data.

In some implementations, a capture tool (i.e., software application) instructs a driver of a parallel processor executing a ray tracing application to write outputs of a ray dispatch that includes a plurality of rays cast for a frame to memory. The tokens are saved in memory for subsequent reconstruction and analysis of the ray tracing data. In some implementations, the tokens represent characteristics of one or more rays in a ray dispatch that includes a plurality of rays for a frame and ray dispatch metadata. The capture tool initiates recording ray tracing data for the frame in response to a user input indicating which frame to capture.

In some implementations, an analysis and visualization tool (software application) accesses the stored tokens, parses the tokens, and reconstructs the ray tracing data represented by the tokens for subsequent analysis. For example, the analysis and visualization tool indexes the reconstructed ray tracing data for statistical sorting and analyzes the ray traversal cost for a ray dispatch by generating a heat map of ray traversal counter data. In some implementations, the analysis and visualization tool records and debugs ray launch arguments, intersection results, correlations to ray tracing acceleration structures, and user ray payload data. The analysis and visualization tool inspects and visualizes ray traversal data in a three-dimensional (3D) environment alongside the acceleration structures in some implementations. For example, in some implementations, the analysis and visualization tool generates a visualization of at least one of ray origin, direction and hit locations, and acceleration structures for the ray dispatch based on the reconstructed ray tracing data. The analysis and visualization tool may generate a visualization of a shader binding table indicating a set of shaders that may be called when ray tracing the frame corresponding to ray hit results and invocations of the shaders based on the reconstructed ray tracing data. Alternatively, or in addition, the analysis and visualization tool may generate a visualization of a hierarchy of ray invocations and timelines based on the reconstructed ray tracing data.

Such visualizations facilitate debugging and optimization of ray tracing applications and allow 3D model artists to measure the impact of their geometry against the costs of ray traversal. In addition, driver and platform developers can use the reconstructed ray tracing data and analysis to debug and optimize the driver software stack implementation to support real-time ray tracing features. Further, hardware modeling engineers can use the reconstructed ray tracing data to measure the ray traversal costs from real-world ray tracing applications.

The techniques described herein are, in different embodiments, employed at any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). Referring now to FIG. 1, a block diagram of a processing system 100 configured to capture real-time ray tracing data and tokenize the data for analysis and debugging is presented, in accordance with some embodiments.

The processing system 100 includes a central processing unit (CPU) 102 and a parallel processor 104, which in some examples is implemented as a graphics processing unit (GPU). In at least some embodiments, the CPU 102, the parallel processor 104, or both the CPU 102 and parallel processor 104 are configured to profile and debug ray traversal data in real time ray tracing pipelines. The CPU 102, in at least some embodiments, includes one or more single- or multi-core CPUs. In various embodiments, the parallel processor 104 includes any cooperating collection of hardware and or software that perform functions and computations associated with accelerating graphics processing tasks, data-parallel tasks, nested data-parallel tasks in an accelerated manner with respect to resources such as conventional CPUs, conventional graphics processing units (GPUs), and combinations thereof.

As illustrated in FIG. 1, the processing system 100 also includes a system memory 106, an operating system 108, a communications infrastructure 110, and one or more applications such as ray tracing application 112. Access to the system memory 106 is managed by a memory controller (not shown) coupled to system memory 106. For example, requests from the CPU 102 or other devices for reading from or for writing to the system memory 106 are managed by the memory controller. In some embodiments, the one or more applications include various programs or commands to perform computations that are also executed at the CPU 102. The CPU 102 sends selected commands for processing at the parallel processor 104. The operating system 108 and the communications infrastructure 110 are discussed in greater detail below. The processing system 100 further includes a driver 114 and a memory management unit, such as an input/output memory management unit (IOMMU) 116. Components of the processing system 100 are implemented as hardware, firmware, software, or any combination thereof. In some embodiments, the processing system 100 includes one or more software, hardware, and firmware components in addition to or different from those shown in FIG. 1.

Within the processing system 100, the system memory 106 includes non-persistent memory, such as DRAM (not shown). In various embodiments, the system memory 106 stores processing logic instructions, constant values, variable values during execution of portions of applications or other processing logic, or other desired information. For example, in various embodiments, parts of control logic to perform one or more operations on the CPU 102 reside within the system memory 106 during execution of the respective portions of the operation by the CPU 102. During execution, respective applications, operating system functions, processing logic commands, and system software reside in the system memory 106. Control logic commands that are fundamental to the operating system 108 generally reside in the system memory 106 during execution. In some embodiments, other software commands (e.g., a set of instructions or commands used to implement the device driver 114) also reside in the system memory 106 during execution by the processing system 100.

The IOMMU 116 is a multi-context memory management unit. As used herein, context is considered the environment within which kernels execute and the domain in which synchronization and memory management is defined. The context includes a set of devices, the memory accessible to those devices, the corresponding memory properties, and one or more command-queues used to schedule execution of a kernel(s) or operations on memory objects. The IOMMU 116 includes logic to perform virtual to physical address translation for memory page access for devices, such as the parallel processor 104. In some embodiments, the IOMMU 116 also includes, or has access to, a translation lookaside buffer (TLB) (not shown). The TLB is implemented in a content addressable memory (CAM) to accelerate translation of logical (i.e., virtual) memory addresses to physical memory addresses for requests made by the parallel processor 104 for data in the system memory 106.

In various embodiments, the communications infrastructure 110 interconnects the components of the processing system 100. The communications infrastructure 110 includes (not shown) one or more of a peripheral component interconnect (PCI) bus, extended PCI (PCI-e) bus, advanced microcontroller bus architecture (AMBA) bus, advanced graphics port (AGP), or other such communication infrastructure and interconnects. In some embodiments, the communications infrastructure 110 also includes an Ethernet network or any other suitable physical communications infrastructure that satisfies an application's data transfer rate requirements. The communications infrastructure 110 also includes the functionality to interconnect components, including components of the processing system 100.

A driver 114 communicates with a device (e.g., parallel processor 104) through an interconnect or the communications infrastructure 110. When a calling program invokes a routine in the driver 114, the driver 114 issues commands to the device. Once the device sends data back to the driver 114, the driver 114 invokes routines in an original calling program. In general, drivers are hardware-dependent and operating-system-specific to provide interrupt handling required for any necessary asynchronous time-dependent hardware interface. In some embodiments, a compiler 118 is embedded within the driver 114. The compiler 118 compiles source code into program instructions as needed for execution by the processing system 100. During such compilation, the compiler 118 applies transforms to program instructions at various phases of compilation. In other embodiments, the compiler 118 is a standalone application. In various embodiments, the driver 114 controls operation of the parallel processor 104 by, for example, providing an application programming interface (API) to software (e.g., applications) executing at the CPU 102 to access various functionality of the parallel processor 104.

The CPU 102 includes (not shown) one or more of a control processor, field-programmable gate array (FPGA), application-specific integrated circuit (ASIC), or digital signal processor (DSP). The CPU 102 executes at least a portion of the control logic that controls the operation of the processing system 100. For example, in various embodiments, the CPU 102 executes the operating system 108, the one or more applications such as the ray tracing application 112, and the driver 114. In some embodiments, the CPU 102 initiates and controls the execution of the one or more applications such as the ray tracing application 112 by distributing the processing associated with one or more applications across the CPU 102 and other processing resources, such as the parallel processor 104.

The parallel processor 104 executes commands and programs for selected functions, such as graphics operations and other operations that are particularly suited for parallel processing. In general, the parallel processor 104 is frequently used for executing graphics pipeline operations, such as pixel operations, geometric computations, and rendering an image to a display. In some embodiments, the parallel processor 104 also executes compute processing operations (e.g., those operations unrelated to graphics such as video operations, physics simulations, computational fluid dynamics, etc.), based on commands or instructions received from the CPU 102. For example, such commands include special instructions that are not typically defined in the instruction set architecture (ISA) of the parallel processor 104.

In some embodiments, the parallel processor 104 is configured to render a set of rendered frames each representing respective scenes within a screen space (e.g., the space in which a scene is displayed) according to one or more applications such as ray tracing application 112 for presentation on a display 130. As an example, the parallel processor 104 renders graphics objects (e.g., sets of primitives) for a scene to be displayed so as to produce pixel values representing a rendered frame. In at least some embodiments, the rendered frame is based on ray tracing operations executed at ray tracing hardware 140. The parallel processor 104 then provides the rendered frame (e.g., pixel values) to display 130. These pixel values, for example, include color values (YUV color values, RGB color values), depth values (z-values), or both. After receiving the rendered frame, display 130 uses the pixel values of the rendered frame to display the scene including the rendered graphics objects. To render the graphics objects, the parallel processor 104 includes the ray tracing hardware 140 and one or more compute units, such as one or more processing cores 120 (illustrated as 120-1 and 120-2) that include one or more single-instruction multiple-data (SIMD) units 122 (illustrated as 122-1 to 122-4) that are each configured to execute a thread concurrently with execution of other threads in a wavefront by other SIMD units 122, e.g., according to a SIMD execution model.

The ray tracing hardware 140 includes one or more circuits collectively configured to execute ray tracing and other texture operations. In particular, the ray tracing hardware 140 is configured to perform intersection operations, to identify whether a given ray intersects with a given BVH node, and traversal operations, to traverse the BVH tree based on the intersection operations. The circuitry of the ray tracing hardware 140, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)).

The SIMD execution model is one in which multiple processing elements share a single program control flow unit and program counter and thus execute the same program but are able to execute that program with different data. The processing cores 120 are also referred to as shader cores (i.e., shaders) or streaming multi-processors (SMXs). The number of processing cores 120 implemented in the parallel processor 104 is configurable. Each processing core 120 includes one or more processing elements such as scalar and or vector floating-point units, arithmetic and logic units (ALUs), and the like. In various embodiments, the processing cores 120 also include special-purpose processing units (not shown), such as inverse-square root units and sine/cosine units.

Each of the one or more processing cores 120 executes a respective instantiation of a particular work item to process incoming data, where the basic unit of execution in the one or more processing cores 120 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a processing core 120.

The parallel processor 104 issues and executes work-items, such as groups of threads executed simultaneously as a “wavefront”, on a single SIMD unit 122. Wavefronts, in at least some embodiments, are interchangeably referred to as warps, vectors, or threads. In some embodiments, wavefronts include instances of parallel execution of a shader program, where each wavefront includes multiple work items that execute simultaneously on a single SIMD unit 122 in line with the SIMD paradigm (e.g., one instruction control unit executing the same stream of instructions with multiple data). A scheduler 124 is configured to perform operations related to scheduling various wavefronts on different processing cores 120 and SIMD units 122 and performing other operations to orchestrate various tasks on the parallel processor 104. To facilitate scheduling of ray tracing operations associated with ray tracing application 112, the scheduler 124 implements a shader binding table (not shown) to indicate a set of shaders that may be called to perform intersection tests or shading calculations when ray tracing a frame. The shader binding table associates each geometry in the frame with a set of shader function handles and parameters for the functions that are passed to the shaders when they are called.

In the depicted embodiment, the parallel processor 104 includes a memory 145 to store ray data (not shown), representing the data associated with the rays used for the ray tracing operations described herein. For example, in some embodiments, the ray data stores, for each ray for which ray tracing is to be performed, a ray identifier (referred to as a ray ID) (in at least some embodiments, the ray ID is not separately stored, but is indicated by the index for the entry or line where the ray data is stored), vector information indicating the origin of the ray in a coordinate frame and the direction of the ray in the coordinate frame, and any other data needed to perform ray tracing operations.

The memory 145 also stores acceleration structures such as a BVH tree (not shown) that are employed by the parallel processor 104 to implement ray tracing operations. The BVH tree includes a plurality of nodes organized as a tree, with bounding boxes or other bounding volumes of objects of a scene to be rendered, wherein the bounding volumes form leaf nodes of the tree structure, and then these nodes are grouped into small sets, with each set enclosed in their own bounding volumes that represent a parent node on the tree structure, and these small sets then are bound into larger sets that are likewise enclosed in their own bounding volumes that represent a higher parent node on the tree structure, and so forth, until there is a single bounding volume representing the top node of the BVH tree and which encompasses all lower-level bounding volumes.

To reduce latency associated with off-chip memory access, various parallel processor architectures include a memory cache hierarchy (not shown) including, for example, L1 cache and a local data share (LDS). The LDS is a high-speed, low-latency memory private to each processing core 120. In some embodiments, the LDS is a full gather/scatter model so that a workgroup writes anywhere in an allocated space.

The parallelism afforded by the one or more processing cores 120 is suitable for graphics-related operations such as pixel value calculations, vertex transformations, tessellation, geometry shading operations, ray tracing, path tracing, and other graphics operations. A graphics processing pipeline 126 accepts graphics processing commands from the CPU 102 and thus provides computation tasks to the one or more processing cores 120 for execution in parallel. Some graphics pipeline operations, such as pixel processing and other parallel computation operations, require that the same command stream or compute kernel be performed on streams or collections of input data elements. Respective instantiations of the same compute kernel are executed concurrently on multiple SIMD units 122 in the one or more processing cores 120 to process such data elements in parallel. As referred to herein, for example, a compute kernel is a function containing instructions declared in a program and executed on parallel processor processing core 120. This function is also referred to as a kernel, a shader, a shader program, or a program.

In some embodiments, the processing system 100 includes input/output (I/O) engine 132 that includes circuitry to handle input or output operations associated with display 130, as well as other elements of the processing system 100 such as keyboards, mice, printers, external disks, and the like. The I/O engine 132 is coupled to the communications infrastructure 110 so that the I/O engine 132 communicates with the memory 106, the parallel processor 104, and the CPU 102. In some embodiments, the CPU 102 issues one or more draw calls or other commands to the parallel processor 104. In response to the commands, the parallel processor 104 schedules, via the scheduler 124, one or more raytracing operations at the ray tracing hardware 140. Based on the raytracing operations, the parallel processor 104 generates a rendered frame, and provides the rendered frame to the display 130 via the I/O engine 132.

In at least some embodiments, the processing system 100 is a computer, laptop/notebook, mobile device, gaming device, wearable computing device, server, or any of various other types of computing systems or devices. It is noted that the number of components of the processing system 100 varies from embodiment to embodiment. In at least some embodiments, there is more or fewer of each component/subcomponent than the number shown in FIG. 1. It is also noted that the processing system 100, in at least some embodiments, includes other components not shown in FIG. 1. Additionally, in other embodiments, the processing system 100 is structured in other ways than shown in FIG. 1.

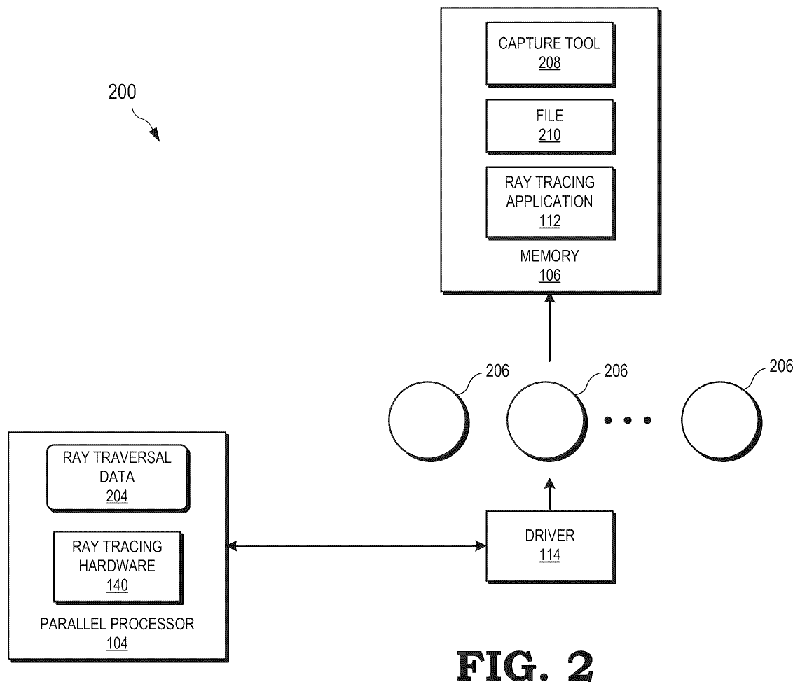

FIG. 2 is a block diagram of a portion of a processing system 200 illustrating the driver 114 generating tokens 206 representing recorded ray traversal data 204 to be saved at a file 210 in memory 106 in accordance with some embodiments. To facilitate capture of the ray traversal data 204, the memory 106 stores a capture tool 208 that generates instructions to the driver 114. The capture tool 208 is a software application that provides a user interface that allows a user to indicate one or more frames for which ray tracing data is to be captured. In some implementations, a user input places the driver 114 in a ray tracing debug mode to record ray traversal data for an indicated frame or frames. In some implementations, the tokens are implemented by shader instructions that are executed by the ray tracing hardware 140.

In response to receiving the instructions from the capture tool 208, the driver 114 adds additional shader instructions to the instructions that are issued by the ray tracing application 112. The additional shader instructions instruct the parallel processor 104 to record the ray traversal data 204 and generate tokens 206 that are compact representations of the ray traversal data 204 for storage at the file 210. In some implementations, the format of the tokens 206 is based on a fixed function, e.g., a fixed number of bits to describe rays that are cast by the ray tracing application 112 for the selected frame, as well as a payload of the rays that describes the direction and other aspects (e.g., color, complications, depth) of each ray. In some embodiments, the driver 114 instructs the parallel processor 104 to generate a token stream including a plurality of tokens 206 for each ray, in which each token 206 includes information regarding different aspects of the ray. For example, in some implementations, a plurality (in some cases, hundreds, thousands, or millions) of tokens 206 describe the beginnings of the rays, other tokens 206 describe the acceleration structure data, still other tokens 206 describe the geometry, yet other tokens 206 describe the intersections of the rays with the acceleration structures and the geometry, and yet another token 206 describes a shader binding table. Additional tokens 206 may describe function calls, the dispatch dimension of a ray, and other aspects of the rays. All of the rays that are dispatched by a single API call are referred to as a ray dispatch, and in some implementations, the driver 114 additionally generates a token 206 for metadata for each ray dispatch indicating, e.g., the dimensions of the ray dispatch.

An example token stream in hexadecimal format with a human readable format for each item shown as a comment (after //) is as follows:
0x80000008 // RayID with Control bit set
0x0013000a // Control DWORD (RayHistoryTokenBegin_v2: 19 DWORDs)
0x00004c31 // RayHistoryTokenBeginData_v2.hwWaveId
0x00000000 // RayHistoryTokenBeginData_v2.dispatchRaysIndex[0]
0x00000000 // RayHistoryTokenBeginData_v2.dispatchRaysIndex[1]
0x00000000 // RayHistoryTokenBeginData_v2.dispatchRaysIndex[2]
0x00000000 // RayHistoryTokenBeginData_v2.accelStructLo
0x00000000 // RayHistory TokenBeginData_v2.accelStructHi
0x00000001 // RayHistoryTokenBeginData_v2.rayFlags
0x00000000 // RayHistoryTokenBeginData_v2.packedTraceParameters
0x3f800000 // RayHistoryTokenBeginData_v2.rayDesc.origin.x
0x3f800000 // RayHistoryTokenBeginData_v2.rayDesc.origin.y
0x3f800000 // RayHistoryTokenBeginData_v2.rayDesc.origin.z
0x00000000 // RayHistoryTokenBeginData_v2.rayDesc.tMin
0x00000000 // RayHistoryTokenBeginData_v2.rayDesc.direction.x
0x00000000 // RayHistoryTokenBeginData_v2.rayDesc.direction.y
0x00000000 // RayHistoryTokenBeginData_v2.rayDesc.direction.z
0x00000000 // RayHistoryTokenBeginData_v2.rayDesc.tMax
0x89abcdef // RayHistoryTokenBeginData_v2.staticId
0x00000001 // RayHistoryTokenBeginData_v2.dynamicId
0xffffffff // RayHistoryTokenBeginData_v2.parentId
0x00000008 // RayID
0x00000027 // NodePtr (top-level)
0x00000008 // RayID
0x00000047 // NodePtr (top-level)
0x00000008 // RayID
0x00000067 // NodePtr (top-level)
0x00000008 // RayID
0x00000087 // NodePtr (top-level)
0x00000008 // RayID
0x000000a7 // NodePtr (top-level)
0x00000008 // RayID
0x000000c7 // NodePtr (top-level)
0x80000008 // Control token
0x00020002 // Control DWORD (RayHistoryTokenBottomLevel: 64-bit address)
0x788bc000 // Lo-bits
0x00000004 // Hi-bits
0x00000008 // RayID
0x00000021 // NodePtr (bottom-level)
0x00000008 // RayID
0x00000041 // NodePtr (bottom-level)
0x80000008 // Control token
0x00060009 // Control DWORD (RayHistoryTokenIntersectionResult_v2: 6 DWORDs)
0x00000001 // RayHistoryTokenIntersectionResultData_v2.primitiveIndex
0x00000001 // RayHistoryTokenIntersectionResultData_v2.geometryIndex
0xfe000003 // RayHistoryTokenIntersectionResultData_v2.instanceIndexAndHitKind
0x00000045 // RayHistoryTokenIntersectionResultData_v2.numIterations
0x00000008 // RayHistoryTokenIntersectionResultData_v2.numInstanceIntersections
0x3f800000 // RayHistoryTokenIntersectionResultData_v2.hitT
0x80000008 // Control token
0x00030007 // Control DWORD (RayHistoryTokenFunctionCall_v2: 3 DWORDs)
0xdeaddead // RayHistoryTokenFunctionCallData_v2.shaderId (Low 32-bits)
0xbeefbeef // RayHistory TokenFunctionCallData_v2.shaderId (High 32-bits)
0x00000008 // RayHistory TokenFunctionCallData_v2.shaderRecordIndex

The driver 114 generates the tokens 206 and stores the token stream at a file 210. In the illustrated example, the file 210 is stored at the memory 106. In other implementations, the file 210 is stored at the memory 145 of the parallel processor 104. Storing the file 210 at the memory 106 versus the memory 145 is a design choice that depends at least in part on bandwidth and memory capacity of the respective memories 106, 145. Although the tokens 206 condense the ray traversal data 204, the memory 145 of the parallel processor 104 may have more limited capacity than the memory 106, and may be fully consumed by the file 210. However, storing the file 210 at the memory 106 introduces additional latency versus storing the file 210 at the memory 145. In some implementations, the file 210 is transmitted, e.g., over a network, to another processing system for subsequent analysis and visualization, as will be described further herein.

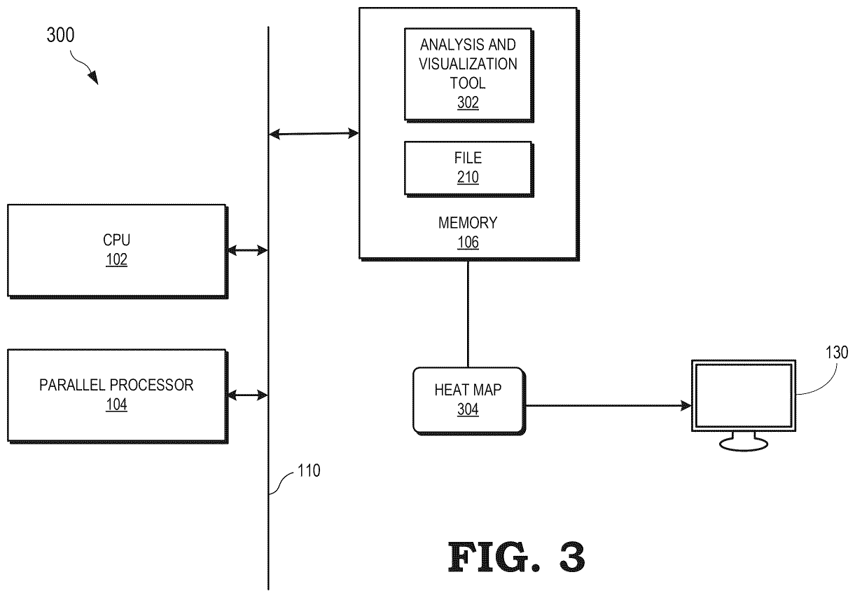

FIG. 3 is a block diagram of a processing system 300 reconstructing ray tracing data from stored tokens for analysis and debugging in accordance with some embodiments. An analysis and visualization tool 302 is an application that generates instructions for parsing the tokens 206 stored at the file 210. Based on the instructions, the CPU 102 issues a draw call to the parallel processor 104 to parse the tokens 206 and reconstruct the ray traversal data 204 represented by the tokens 206 to perform correlation, analysis, and visualization of the output ray traversal data 204.

In some implementations, the processing system 300 indexes the ray traversal data 204 for statistical sorting that facilitates discovery of suboptimal scenarios, such as an unwarranted expenditure of computational resources for rays that have limited value. Based on the reconstructed ray traversal data 204, the CPU 102 issues a draw call to the parallel processor 104 to build a visualization of ray traversal counter data as an interactive heat map 304 in some embodiments. The heat map 304 is output for display to a user at display 130, enabling efficient analysis of ray traversal cost for an entire ray dispatch.

In other implementations, the CPU 102 issues a draw call to the parallel processor 104 to generate a 3D visualization of ray origin, direction, and hit locations with associated acceleration structures based on the ray traversal data 204 reconstructed from the parsed tokens 206. Such a 3D visualization allows developers to record and debug ray launch arguments and user ray payload data. The reconstructed ray traversal data 204 additionally facilitates generating a display illustrating a hierarchy of ray invocations and timelines.

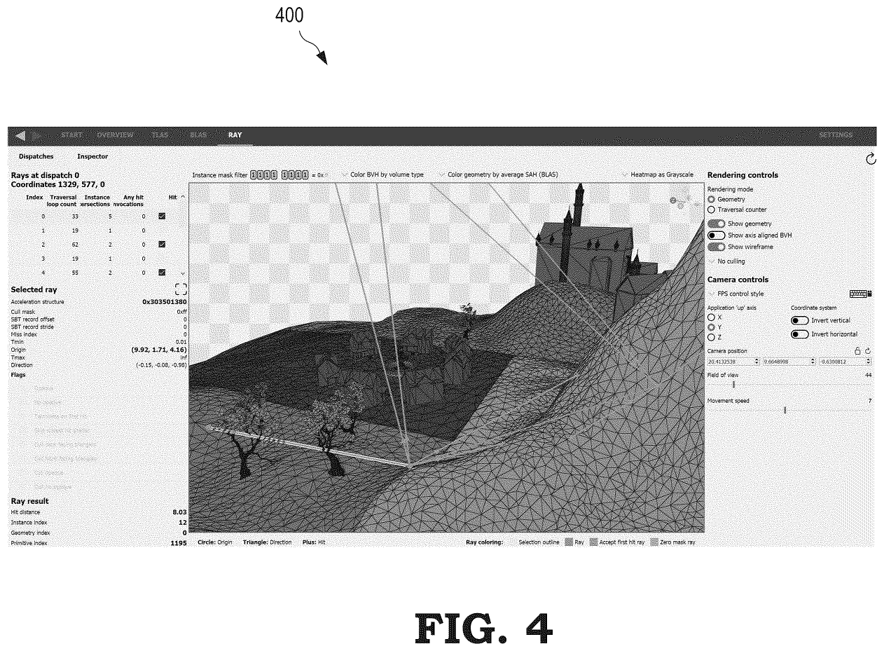

FIG. 4 is an illustration of visualization 400 of analysis of ray traversal data 204 reconstructed from parsed tokens 206 in accordance with some embodiments. The visualization 400 allows a user to inspect each ray and see the user payload and the intrinsic payload. The visualization 400 allows a developer to determine whether each ray has the correct function arguments and directions, as well as the cost of various details in the frame. Based on the information available in the visualization 400, a user can determine whether the geometry of the frame is in the intended order or whether the geometry could be simplified to reduce the cost of the frame without negatively impacting the generated image.

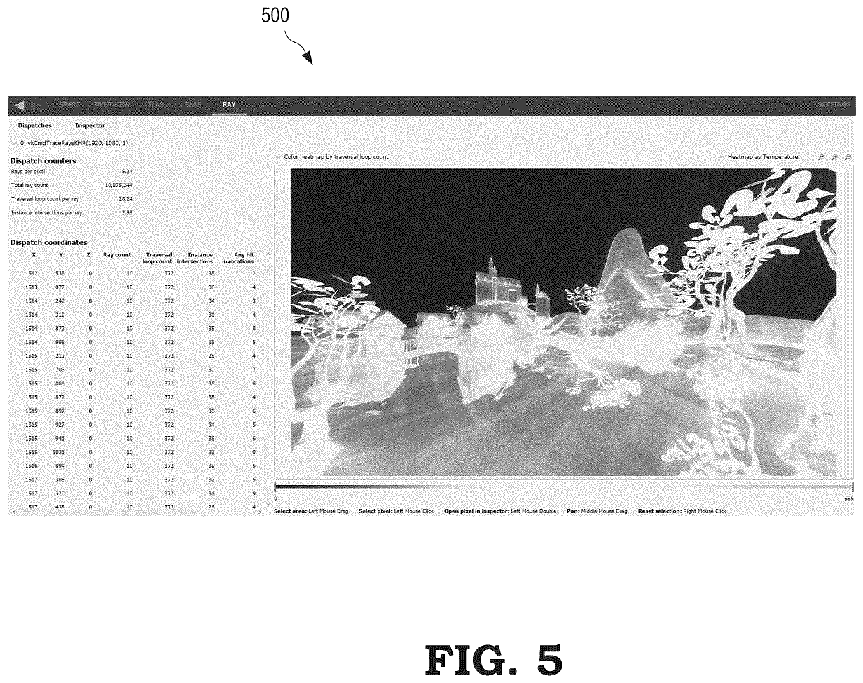

FIG. 5 is an illustration of a heat map 500 generated from ray traversal data 204 reconstructed from stored tokens 206 in accordance with some embodiments. The heat map 500 visualizes how many traversals, or loops, are associated with each pixel. In some implementations, the heat map also shows one or more of the number of rays, intersection results, function call hit invocations, or other metrics. A single ray can generate additional rays as the ray hits geometry in the frame, and the heat map 500 indicates a count of traversals for each pixel. Each traversal incurs additional computation costs, so the higher the traversal count for a pixel, the more computationally expensive the pixel is. Thus, the heat map 500 enables developers to easily visualize the cost per pixel of a frame of the ray tracing application 112.

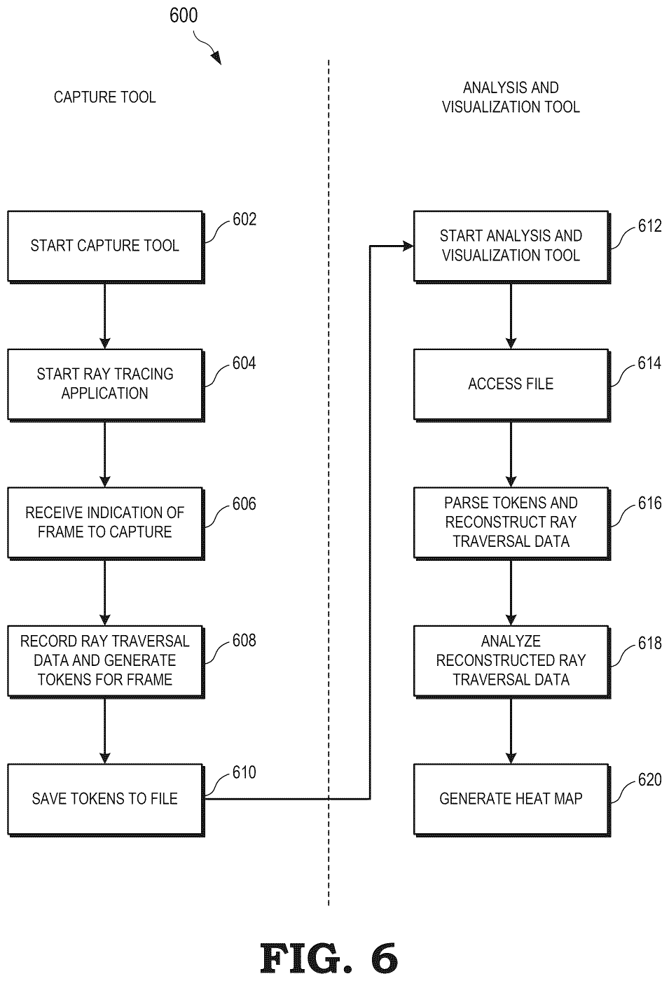

FIG. 6 is a flow diagram illustrating a method 600 for tokenizing ray tracing data captured from real-time ray tracing functionality and reconstructing the ray traversal data for analysis and debugging in accordance with some embodiments. In some implementations, the method 600 is performed by a processing system such as processing system 100.

At step 602, a software application such as capture tool 208 is started. In some implementations, starting the capture tool 208 enables a user input to place a device driver such as driver 114 in a ray tracing debug mode to record ray traversal data for an indicated frame or frames. At step 604, a ray tracing application such as ray tracing application 112 is started. The ray tracing application 112 generates instructions to ray tracing hardware such as ray tracing hardware 140 to perform ray tracing operations that generate ray traversal data such as ray traversal data 204.

At step 606, the capture tool 208 receives a user input indicating a frame for which ray traversal data 204 is to be recorded. At step 608, the capture tool 208 instructs the driver 114 to issue shader instructions to capture the ray traversal data 204 for the indicated frame and generate tokens such as tokens 206 representing the ray traversal data 204 in a compact format such as a hexadecimal format. The tokens 206 represent various aspects of the ray traversal data, such as the beginnings of the rays, acceleration structure data, geometry, intersections of the rays with the acceleration structures and the geometry, a shader binding table, function calls, the dispatch dimension of the rays, user payload, and intrinsic payload. In some implementations, the driver 114 additionally generates a token 206 for metadata for each ray dispatch indicating the dimensions of the ray dispatch. At step 610, the driver 114 saves the tokens 206 to a file 210. In some implementations, the file is stored at a memory 145 of the parallel processor 104, and in other implementations, the file is stored at a system memory such as memory 106. In yet other implementations, the file is transmitted, e.g., via a network, to another processing system for analysis and visualization.

Once the ray traversal data has been captured and tokenized, the method then proceeds to step 612, at which an analysis and visualization tool such as analysis and visualization tool 302 is started, either at the same processing system 100 at which the ray tracing application 112 is executing, or at a separate processing system. At step 614, the analysis and visualization tool 302 accesses the file 210. The analysis and visualization tool 302 then parses the tokens 206 and reconstructs the ray traversal data 204 at step 616.

At step 618, the analysis and visualization tool 302 analyzes the reconstructed traversal data 204, e.g., by issuing instructions to components of the processing system 300 such as the CPU 102 and/or the parallel processor 104. At step 620, the analysis and visualization tool 302 generates one or more of a visualization 400 of analysis of ray traversal data 204 reconstructed from parsed tokens 206 and a heat map 500 illustrating how many traversals, or loops, are associated with each pixel. Based on the outputs of the analysis and visualization tool 302, a developer can debug and improve the cost profile of the ray tracing application 112.

In some embodiments, the apparatus and techniques described above are implemented in a system including one or more integrated circuit (IC) devices (also referred to as integrated circuit packages or microchips), such as the processing system described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
recording ray traversal data for a frame during execution of a ray tracing application at a processor;
generating tokens representative of the ray traversal data; and
saving the tokens at a memory.

2. The method of claim 1, wherein the tokens represent characteristics of one or more rays in a ray dispatch comprising a plurality of rays cast for the frame and ray dispatch metadata.

3. The method of claim 1, further comprising:
instructing a driver of a parallel processor executing the ray tracing application to write outputs of a ray dispatch to the memory.

4. The method of claim 1, wherein recording the ray traversal data for the frame is in response to receiving a user input indicating the frame.

5. The method of claim 1, further comprising:
parsing the tokens; and
reconstructing the ray traversal data for the frame based on the parsed tokens.

6. The method of claim 5, further comprising:
indexing the reconstructed ray traversal data for statistical sorting.

7. The method of claim 5, further comprising:
generating a visualization of the reconstructed ray traversal data as a heat map.

8. The method of claim 5, further comprising:
generating a visualization of at least one of: ray origin, direction and hit locations, and acceleration structures for a ray dispatch comprising a plurality of rays cast for the frame based on the reconstructed ray traversal data.

9. The method of claim 5, further comprising:
generating a visualization of a shader binding table corresponding to ray hit results and invocations based on the reconstructed ray traversal data.

10. The method of claim 5, further comprising:
generating a visualization of a hierarchy of ray invocations and timelines based on the reconstructed ray traversal data.

11. A processing system, comprising:
a memory; and
at least one parallel processor to:
record ray traversal data for a frame during execution of a ray tracing application;
generate tokens representative of the ray traversal data; and
save the tokens to a file at the memory.

12. The processing system of claim 11, wherein the tokens represent characteristics of one or more rays in a ray dispatch comprising a plurality of rays cast for the frame and ray dispatch metadata.

13. The processing system of claim 11, wherein the at least one parallel processor is further to:
instruct a driver of a parallel processor executing the ray tracing application to write outputs of a ray dispatch to the memory.

14. The processing system of claim 11, wherein the at least one parallel processor is further to:
receive a user input indicating the frame, wherein recording the ray traversal data for the frame is in response to receiving the user input.

15. The processing system of claim 11, further comprising:
a central processing unit (CPU) to:
parse the tokens; and
reconstruct the ray traversal data for the frame based on the parsed tokens.

16. The processing system of claim 15, wherein the CPU is further to:
index the reconstructed ray traversal data for statistical sorting.

17. The processing system of claim 15, wherein the CPU is further to:
issue a draw call instructing the parallel processor to generate a visualization of the reconstructed ray traversal data as a heat map.

18. The processing system of claim 15, wherein the CPU is further to:
issue a draw call instructing the parallel processor to generate a visualization of at least one of: ray origin, direction and hit locations, and acceleration structures for a ray dispatch comprising a plurality of rays cast for the frame based on the reconstructed ray traversal data.

19. The processing system of claim 15, wherein the CPU is further to:
issue a draw call instructing the parallel processor to generate at least one of:
a visualization of a shader binding table corresponding to ray hit results and invocations based on the reconstructed ray traversal data; and
a visualization of a hierarchy of ray invocations and timelines based on the reconstructed ray traversal data.

20. A non-transitory computer readable medium embodying a set of executable instructions, the set of executable instructions to manipulate at least one processor to:
record ray traversal data for a frame during execution of a ray tracing application;
generate tokens representative of the ray traversal data; and
save the tokens to a file at a memory.
